(19) United States
(12) Patent Application Publication
(10) Pub. No.: US 2026/0128992 A1
(43) Pub. Date: May 7, 2026

(54) TELECOMMUNICATION NETWORK CAPACITY FORECASTING METHOD AND APPARATUS FOR IMPLEMENTING THE SAME

(71) Applicant: Rakuten Mobile, Inc., Tokyo (JP)

(72) Inventors: Sambeet KUMAR, Tokyo (JP); Medithe MADHUKIRAN, Weybridge (GB)

(21) Appl. No.: 18/937,018

(22) Filed: Nov. 5, 2024

(51) Int. Cl. H04L 47/127; H04L 41/5009; H04L 43/0882

(52) U.S. Cl. CPC H04L 47/127; H04L 41/5009; H04L 43/0882

(57) ABSTRACT

A method includes receiving, at an apparatus, telecommunication network data including cumulative daily data and peak utilization data. A neural net-based time series model on the apparatus generates a forecasted number of users in a cell of the network and a forecasted traffic load in the cell of the network, each based on the cumulative daily data. A machine learning regression model on the apparatus calculates a predicted peak utilization of the cell of the network from the forecasted number of users and the forecasted traffic load of the cell.

### FIELD

The present disclosure relates to capacity forecasting method in telecommunication applications and an apparatus for implementing the same.

### BACKGROUND

The information disclosed in this background section is only for enhancement of understanding of the general background of the disclosure and should not be taken as an acknowledgement or any form of suggestion that this information forms the prior art already known to a person skilled in the art.

Telecommunication, e.g., cellular, systems serve an increasing number of users throughout expanding geographic areas. A given radio access network (RAN) includes a large number of cells having overlapping coverage areas and a variety of sizes and signal strengths. In some cases, network operators have roaming partnerships in which one network operator owns the infrastructure of a given cell, e.g., a cell tower and radio unit (RU), and leases out capacity to one or more roaming partners, sometimes referred to as greenfield operators. To serve an increasing number of users, a given network operator expands by adding cell capacity, for example by adding cells or by replacing a roaming cell with a non-roaming cell.

### SUMMARY

The present disclosure is directed to forecasting telecommunication capacity by utilizing advanced machine learning algorithms and real-time data analytics, thereby providing telecommunication operators with precise and actionable insights into future network capacity requirements.

In some embodiments, a method includes receiving, at an apparatus, telecommunication network data including cumulative daily data and peak utilization data. A neural net-based time series model on the apparatus generates a cumulative daily forecasted number of users and traffic load of a cell in the network, each based on the cumulative daily data. A machine learning regression model on the apparatus calculates a predicted peak utilization of a cell of the network from the cumulative daily forecasted number of users and the forecasted traffic load.

In some embodiments, a method includes receiving, at an apparatus, telecommunication network key performance indicator (KPI) data including cumulative daily data and peak utilization data. A neural net-based time series model on the apparatus generates a cumulative daily forecasted number of users and traffic load of the cells in the network, each based on the cumulative daily data. A machine learning regression model on the apparatus calculates a predicted peak utilization of a cell of the network from the cumulative daily forecasted number of users and the forecasted traffic load. In response to the predicted peak utilization of the cell, a first network resource configuration operation is performed.

In some embodiments, an apparatus includes a neural net-based time series model and a machine learning regression model. The neural net-based time series model is configured to receive telecommunication network KPI data including cumulative daily data and generate a cumulative daily forecasted number of users and traffic load of one or more cells in the network, each based on the cumulative daily data. The machine learning regression model is configured to calculate a predicted peak utilization of a cell of the network from the cumulative daily forecasted number of users and the forecasted traffic load.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a diagram of example components of a telecommunication system, in accordance with some embodiments.

FIG. 2 is a diagram of example capacity forecasting operations, in accordance with some embodiments.

FIG. 3 is a diagram of example operations of a capacity forecasting method, in accordance with some embodiments.

FIG. 4 is a diagram of example components of a capacity forecasting apparatus, in accordance with some embodiments.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

In various embodiments, some or all of a method, apparatus, and computer readable medium are directed to receiving, at a neural net-based time series model, telecommunication data, e.g., network key performance indicator (KPI) data, including cumulative daily data and peak utilization data. The neural net-based time series model generates a forecasted number of users of the network and a forecasted traffic load of the network, each based on the cumulative daily data and peak utilization data. A machine learning regression model calculates a predicted peak utilization of a cell of the network from the forecasted number of users and the forecasted traffic load. In some embodiments, in response to the predicted peak utilization of the cell, a first network resource configuration operation is performed.

Using the neural net-based time series model in combination with the machine learning regression model enables network capacity forecasts that are more accurate and timely than those provided in other approaches, thereby allowing for better planning, resource allocation, and overall network management, ultimately leading to a more resilient and efficient telecommunications infrastructure.

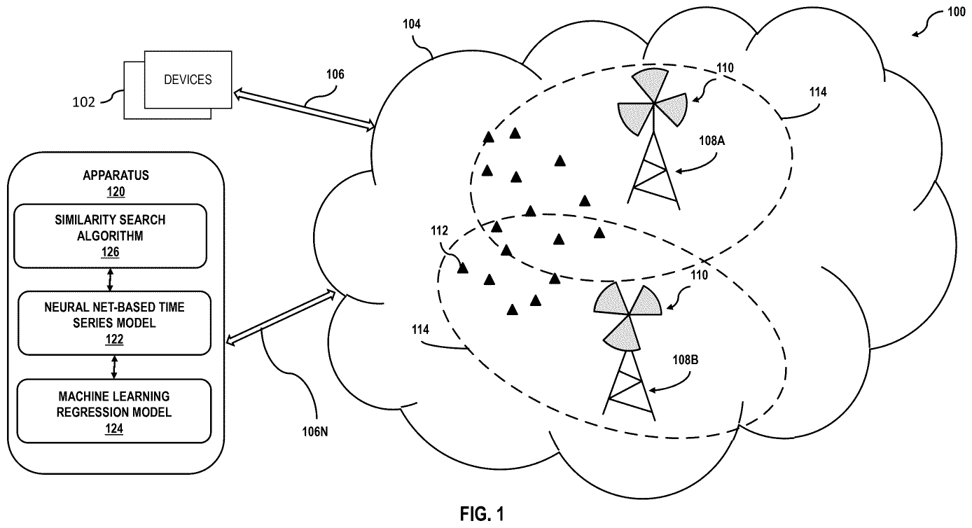

FIG. 1 is a diagram of a telecommunication system 100 (hereinafter referred to as “system 100”), in accordance with some embodiments. FIG. 1 is simplified for the purpose of illustration. System 100 includes devices 102 coupled to a network 104 by links 106. Network 104 is coupled to an apparatus 120 by a link 106N of links 106. Devices 102 and apparatus 120 are coupled to each other through network 104 and links 106 including link 106N.

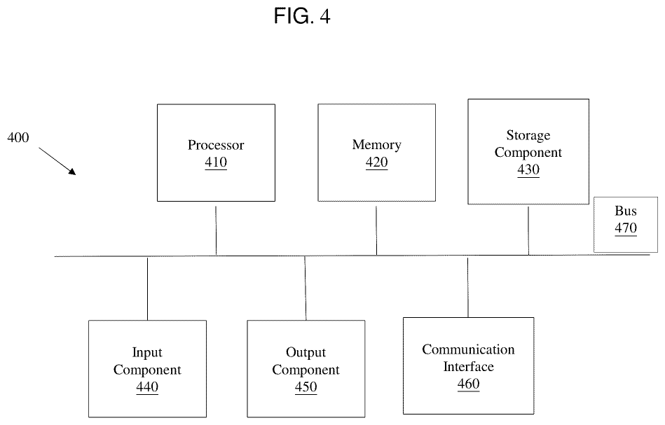

In various embodiments, devices 102 correspond to combinations of computing devices, computing systems, servers, server clusters, and/or pluralities of server clusters also referred to as server farms or data centers in some embodiments. In some embodiments, a device 400 discussed below with respect to FIG. 4 is an embodiment of a device 102 and/or apparatus 120.

In some embodiments, one or more of devices 102 or apparatus 120 is a type of mobile terminal, fixed terminal, or portable terminal including a desktop computer, laptop computer, notebook computer, netbook computer, tablet computer, wearable circuitry, mobile handset, server, gaming console, stationary or moving sensor, or combination thereof. In some embodiments, one or more of devices 102 or apparatus 120 includes a display by which a user interface is displayed. Other configurations and/or types of devices 102 or apparatus 120 are within the scope of the present disclosure.

In the embodiment depicted in FIG. 1, apparatus 120 includes a neural net-based time series model 122, a machine learning regression model 124, and, in some embodiments, a similarity search algorithm 126. In the embodiment depicted in FIG. 1, apparatus 120 including neural net-based time series model 122, machine learning regression model 124, and, if present, similarity search algorithm 126 is a single instance of a computing device, e.g., device 102. In some embodiments, apparatus 120 including neural net-based time series model 122, machine learning regression model 124, and, if present, similarity search algorithm 126 includes more than one instance of a computing device. Each of neural net-based time series model 122, machine learning regression model 124, and, if present, similarity search algorithm 126 is further discussed below.

Network 104 is one or more interconnected devices (not depicted individually) configured to provide electronic communications between and among the interconnected devices and plurality of devices 102, in some cases through plurality of links 106. In some embodiments, network 104 corresponds to the internet.

In some embodiments, network 104 includes or represents a radio-access network (RAN), a mobile telecommunication system that implements a radio access technology (RAT) and resides between devices such as mobile phones, computers, or other devices and provides connection with plurality of devices 102.

In some embodiments, one or more of the interconnected devices of network 104 and/or plurality of devices 102 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices of network 104 and/or plurality of devices 102 are configured as a backbone or core network (CN), a part of a computer network that interconnects networks, providing a path for the exchange of information between different LANs, WANs, etc.

In some embodiments, some of the interconnected devices of network 104 and/or devices 102 are configured as server clusters, e.g., included in a data center. In some embodiments, the server clusters are part of a cloud computing environment.

In the embodiment depicted in FIG. 1, network 104 includes base stations 108A and 108B (hereinafter base station 108), each including an antenna 110 wirelessly connected to one or more instances of user equipment (UE) 112 located in a geographic coverage area 114. In some embodiments, network 104 is a global system for mobile communications (GSM) RAN, a GSM/EDGE RAN, a universal mobile telecommunications system (UMTS) RAN (UTRAN), an evolved universal terrestrial radio access network (E-UTRAN, open RAN (O-RAN), or cloud-RAN (C-RAN). In some embodiments, network 104 resides between a UE 112 (e.g., mobile phone, a computer, or any remotely controlled machine) and one or more core networks.

In some embodiments, network 104 is a hierarchical telecommunications network including one or more intermediate link(s), also referred to as backhaul portions in some embodiments, between a RAN and one or more core networks. Two common methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul generally refers to the side of the network that communicates with the global internet. UEs 112 communicating with a base station 108 constitute a local subnetwork. In some embodiments, a backhaul includes wired, fiber optic, and/or wireless components including microwave bands and mesh and edge network topologies that use a high-capacity wireless channel to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, a base station 108 is a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers, transceivers, digital signal processors, control electronics, a remote radio head (RRH), primary and backup electrical power sources, and sheltering. Base stations are known by other names such as base transceiver station, mobile phone mast, or cell tower. In some embodiments, base stations are edge devices configured to wirelessly communicate with UEs. The edge device provides an entry point into service provider core networks. Examples include routers, routing switches, integrated access devices (IADs), multiplexers, and a variety of MAN and WAN access devices.

In at least one embodiment, an instance of antenna 110 is a sector antenna, e.g., a directional microwave antenna with a sector-shaped radiation pattern, or a plurality of sector antennae, e.g., configured to have a full-circle coverage area 114. In some embodiments, an instance of antenna 110 is a circular antenna. In some embodiments, an instance of antenna 110 operates at microwave or ultra-high frequency (UHF) frequencies (300 Megahertz (MHz) to 3 Gigahertz (GHz)), or at frequencies above 3 GHz.

In various embodiments, a geographic coverage area 114, also referred to as a cell 114 in some embodiments, is a three-dimensional space having a shape and size based on the configurations of the corresponding base station 108, e.g., a power level, and antenna 110, e.g., a number of sectors. In various embodiments, a geographic coverage area 114 has a substantially spherical, hemispherical, conical, columnar, circular or oval disc, or other shape corresponding to a base station and antenna configuration. In various embodiments, one or both of the shape or size of a geographic coverage area 114 varies over time, e.g., based on a variable base station power level and/or a variable number of activated antennae and/or antenna sectors.

In some embodiments, a geographic coverage area 114 is referred to as a macro-cell, a micro-cell, a pico-cell, a femto-cell, or a small cell. In some embodiments, a coverage area 114 is referred to as an indoor small cell (IDSC).

Some or all instances of base station 108 are configured to transmit reference signals including at least one primary synchronization signal (PSS), at least one secondary synchronization signal (SSS), and additional physical channel signals. The physical channel signals include master information blocks (MIBs) and system information blocks (SIBs) that together include cell identifiers, tracking area codes, cell availability indicators (e.g., suitable, acceptable, reserved., barred, available to closed subscriber group only), service level indicators, time and/or frequency resource allocation indicators, and other information relevant to cell-based communications.

In some embodiments, an instance of UE 112 is a computer or computing system. In some embodiments, an instance of UE 112 has a liquid crystal display (LCD), light-emitting diode (LED) or organic light-emitting diode (OLED) screen interface, such as a graphical user interface providing a touchscreen interface with digital buttons and keyboard or physical buttons along with a physical keyboard. In some embodiments, an instance of UE 112 connects to the internet and interconnects with other devices. In some embodiments, an instance of UE 112 incorporates integrated cameras, the ability to place and receive voice and video telephone calls, video games, and Global Positioning System (GPS) capabilities. In some embodiments, an instance of UE 112 performs as a virtual machine or allows third-party apps to run as a container. In some embodiments, an instance of UE 112 is a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card. In some embodiments, a given instance of UE 112 corresponds to device 400 discussed below with respect to FIG. 4.

In some embodiments, a user of network 104, e.g., a user of a device 102, accesses network 104 through a service provider, a business or organization that sells bandwidth or network access by providing direct internet backbone access to internet service providers and usually access to its network access points (NAPs). Service providers are sometimes referred to as backbone providers or internet providers. Service providers consist of telecommunications companies, data carriers, wireless communications providers, internet service providers, and cable television operators offering high-speed internet access.

Links 106 include hardware configured to enable electronic communications between devices 102 and network 104. In various embodiments, one or more of links 106 is a wired link, e.g., fiber optic, shielded, twisted pair, or other cabling, or a wireless link type. In various embodiments, one or more of links 106 is configured to communicate based on code division multiple access (CDMA), wideband CDMA (WCDMA), time division multiple access (TDMA), frequency division multiple access (FDMA), Orthogonal Frequency Division Multiplexing (OFDM), time division duplexing (TDD), frequency division duplexing (FDD), Bluetooth, Infrared (IR), or the like, or other protocols that may be used in a wired or wireless data communications network.

In some embodiments, one or more devices 102 are configured as a performance monitoring system, also referred to as PMS 102 in some embodiments, configured to monitor the performance of a given telecommunications network 104, also referred to as RAN 104 in some embodiments, of system 100. PMS 102 is configured to receive comprehensive cell-level Key Performance Indicators (KPIs) from the various components of RAN 104, e.g., base stations 108 of cells 114.

Non-limiting examples of KPIs include critical metrics such as Physical Resource Block (PRB) utilization, the number of connected users, traffic volume (or load), throughput, UE 112 availability, accessibility, retainability, and integrity, and other relevant performance indicators. PMS 102 is configured to use the KPI data as part of assessing the operational efficiency and performance of each cell within RAN 104, internally and/or by exporting some or all of the KPI data as raw or processed data.

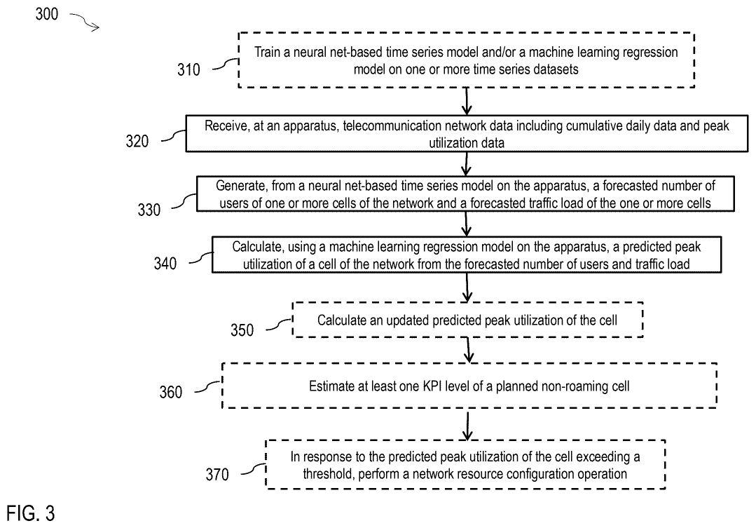

Apparatus 120 is one or more devices configured to execute some or all of method 300 discussed below with respect to FIG. 3. Neural net-based time series model 122 of apparatus 120 is an advanced deep learning model configured to analyze vast amounts of historical data to incorporate and apply general knowledge to learning patterns across a variety of time series datasets from various contexts.

Apparatus 120 is configured to receive the time series datasets as KPI data, e.g., from PMS 102, including cumulative daily data and peak utilization data from some or all of cells 114 in RAN 104. In various embodiments, peak utilization data corresponds to peak utilization periods within each day or within another time period, e.g., a week or a predetermined portion of a day.

The cumulative daily-level data provides a broad view of RAN 104 performance over extended periods. This granularity is essential for identifying long-term trends in network usage, assessing overall growth patterns, and making strategic decisions about future capacity planning. In operation, neural net-based time series model 122 analyzes daily data to understand how performance evolves over time and provides insights into gradual shifts in user behavior and network demand.

The peak utilization data focuses on short-term, peak utilization periods within each time period, e.g., day. This fine-grained data is critical for pinpointing peak traffic loads and understanding the network's capacity requirements during high-demand periods. By examining busy hour metrics, in operation, neural net-based time series model 122 is capable of accurately forecasting and addressing short-term capacity needs, ensuring that RAN 104 can handle peak usage efficiently without degradation in service quality.

The integration of both daily and peak utilization data allows neural net-based time series model 122 to deliver a comprehensive and nuanced forecast. The daily-level analysis captures long-term trends and seasonal variations, while the busy hour analysis provides insights into peak demand periods, facilitating precise capacity planning and management. This combination ensures that the forecasts are both accurate and actionable, enabling telecom operators to maximize network performance and resource allocation effectively.

Neural net-based time series model 122 is configured to generate a cumulative daily forecasted number of users in one or more cells of RAN 104 and a forecasted traffic load in one or more cells of RAN 104, each based on the cumulative daily data. In some embodiments, a forecasted load of RAN 104 includes downlink PRB utilization and/or one or more other KPI levels.

In some embodiments, apparatus 120 is configured to receive one or more target dates, e.g., from a user of apparatus 120, and neural net-based time series model 122 is configured to generate one or more forecasted numbers of users and network traffic loads for a cell based on the one or more target dates.

Machine learning regression model 124 is configured to, in operation, receive the forecasted number of network users and network traffic volumes for each of one or more cells from neural net-based time series model 122 as inputs, and calculate a predicted peak utilization of a cell 114 of RAN 104 from the forecasted number of network users and network traffic volumes.

In some embodiments, calculating the predicted peak utilization of a cell 114 includes predicting a downlink PRB (DL_PRB) utilization of the cell and a percentage of maximum allowed users of the cell, and applying the following equation:

$$Capacity = W 1 * DL\_PRB \_Utilization + W 2 * ( Max\_Users / Allowed\_Max \_Users * 100 ) \qquad ( 1 )$$

wherein DL_PRB_Utilization is DL_PRB expressed as a percentage of the PRB capacity of the cell, Max_Users is the predicted number of users of the cell, Allowed_Max_Users is the maximum number of allowed users of the cell, W1 and W2 are fractional weights whose sum is equal to one, and capacity is the peak utilization of the cell given as a percentage ranging from zero to 100.

The values of weights W1 and W2 correspond to the criticality of the respective one of DL_PRB utilization or percentage of maximum allowed users in a capacity assessment of the cell 114, with higher values corresponding to increased criticality. In some embodiments, weight W1 is equal to 0.8 and weight W2 is equal to 0.2. In some embodiments, each of weights W1 and W2 is equal to 0.5. In some embodiments, one of weights W1 or W2 has a value ranging from 0.1 to 0.5 and the other of weights W1 or W2 has a corresponding value ranging from 0.9 to 0.5. In some embodiments, one of weights W1 or W2 is equal to zero and the other of weights W1 or W2 is equal to one, reflecting a case in which the corresponding one of DL_PRB utilization or percentage of maximum allowed users is entirely critical in the capacity assessment of the cell 114.

In various embodiments, weights W1 and W2 have predetermined values or are received from a user of apparatus 120 or from a network, e.g., from RAN 104 over link 106N. In some embodiments, weights W1 and W2 have values corresponding to, e.g., determined by, a network operator.

In some embodiments, apparatus 120 is configured to, in operation, compare the capacity calculated by models 122 and 124, e.g., as discussed above or as discussed below with respect to the various embodiments, to at least one cell capacity threshold, and perform an operation corresponding to a resource configuration of RAN 104 in response to the calculated capacity equaling and/or exceeding the at least one cell capacity threshold. In various embodiments, the at least one cell capacity threshold is one or more predetermined levels or is one or more levels received from a user of apparatus 120 or a network, e.g., RAN 104. In some embodiments, the cell capacity threshold has one or more levels corresponding to, e.g., determined by, a network operator.

In various embodiments, the operation corresponding to the resource configuration of RAN 104 includes outputting a notification to a user of apparatus 120 and/or RAN 104 of the at least one cell capacity threshold being exceeded, and/or outputting data indicative of the at least one cell capacity threshold being exceeded to a network configuration system, apparatus, database, or one or more software modules corresponding to RAN 104, e.g., over link 106N.

By the configuration discussed above, apparatus 120 including neural net-based time series model 122 and machine learning regression model 124 is capable of providing network capacity forecasts, also referred to as organic growth forecasts in some embodiments, that are more accurate and timely than those provided in other approaches, thereby allowing for better planning, resource allocation, and overall network management, ultimately leading to a more resilient and efficient telecommunications infrastructure.

In some embodiments, apparatus 120 and neural net-based time series model 122 are configured to, in operation, receive a target increase in the forecasted number of users of the network, e.g., from a user of apparatus 120 or RAN 104 over link 106N. Neural net-based time series model 122 is configured to generate an estimated increase in the forecasted number of users based on the received target increase. To estimate the increase, neural net-based time series model 122 uses a combination of factors including a population penetration factor, historical trends, and/or future planned cell deployments. The population penetration factor helps determine the potential market saturation and the likelihood of subscriber uptake in specific regions. Historical trends leverage past growth patterns and user behavior to help predict future increases in subscriber numbers and traffic volumes. Plans for future cell deployments are taken into account based on the influence of new cells on the distribution and capacity of the network.

Neural net-based time series model 122 is also configured to generate an updated forecasted number of users of RAN 104 and an updated forecasted traffic load of RAN 104, each based on the estimated increase. Machine learning regression model 124 is configured to calculate an updated predicted peak utilization of the cell 114 from the updated forecasted number of users and the updated forecasted traffic load.

In such embodiments, apparatus 120 including neural net-based time series model 122 and machine learning regression model 124 is capable of performing a comprehensive assessment of RAN 104's ability to handle the targeted subscriber growth and ensure that sufficient capacity is planned to meet the increased demand. By incorporating targeted subscriber growth into the capacity forecasting model, telecom operators can proactively manage network expansion and resource allocation. This approach ensures that the network can accommodate both organic and targeted growth, maintaining high service quality and meeting strategic business objectives.

In some embodiments, apparatus 120 includes similarity search algorithm 126, and neural net-based time series model 122 and similarity search algorithm 126 are configured to, in operation, receive information corresponding to a scheduled event, e.g., from a user of apparatus 120 or RAN 104 over link 106N. Neural net-based time series model 122 and similarity search algorithm 126 are configured to identify a past event similar to the scheduled event based on the information. To identify the past event, similarity search algorithm 126 correlates specific items of the information of the current event with those of historical events in the network. Non-limiting examples of key factors considered in this analysis include the type of event, the location, and the anticipated number of attendees. By leveraging historical data, similarity search algorithm 126 identifies past events having characteristics that closely match the characteristics of the scheduled event.

Neural net-based time series model 122 is also configured to, based on the past event identified by similarity search algorithm 126, identify a subset of cells 114 of RAN 104 corresponding to the scheduled event, and estimate, for each cell 114 of the subset of cells, an increase in a forecasted number of cell users and an increase in a forecasted cell traffic load. Machine learning regression model 124 is configured to calculate, for each cell 114 of the subset of cells, a predicted peak utilization of the corresponding cell from the corresponding increased forecasted number of cell users and increased forecasted cell traffic load.

In such embodiments, apparatus 120 including neural net-based time series model 122 and machine learning regression model 124 is capable of predicting event capacity loads such that telecom operators can proactively manage network resources and plan for temporary site deployments if necessary. This capability ensures that the network can handle the increased demand without compromising service quality, providing a seamless experience for users during high-traffic events. The approach also helps optimize network performance and prevents potential service degradation due to unexpected capacity strains.

In some embodiments, an organic growth forecast as discussed above corresponds to the cell 114 being a roaming cell, and similarity search algorithm 126 is configured to, in operation, identify at least one most similar second roaming cell 114 by performing a machine learning-based time series similarity analysis of the first roaming cell 114 and other roaming cells 114 of RAN 104 proximate to non-roaming cells 114 of RAN 104. This analysis considers KPI trends, incorporates spatial characteristics such as population density and the region where the cells are located, and/or matches cell location characteristics such as office or retail spaces. These factors significantly influence network behavior and are critical in establishing accurate correlations between roaming and non-roaming cells.

Based on one or more KPI levels of the at least one most similar second roaming cell 114 relative to one or more KPI levels of the corresponding at least one proximate non-roaming cell 114, neural net-based time series model 122 and machine learning regression model 124 together estimates at least one KPI level of the one or more KPI levels of a planned non-roaming cell of RAN 104 corresponding to the first roaming cell 114.

In such embodiments, a dual understanding of both the roaming KPIs and the translated non-roaming load for current roaming cells 114 is vital for effective RAN 104 planning. It enables telecom operators to prioritize which cells 114 require attention, whether for capacity expansion, optimization, or new deployments. Furthermore, it aids in determining the most appropriate type of deployment, ensuring that RAN 104 resources are allocated efficiently to maintain high service quality. This embodiment is particularly advantageous in optimizing costs associated with domestic roaming agreements, as it facilitates better management of traffic and capacity in these shared network areas, leading to more informed decision-making and enhanced operational efficiency compared to other approaches.

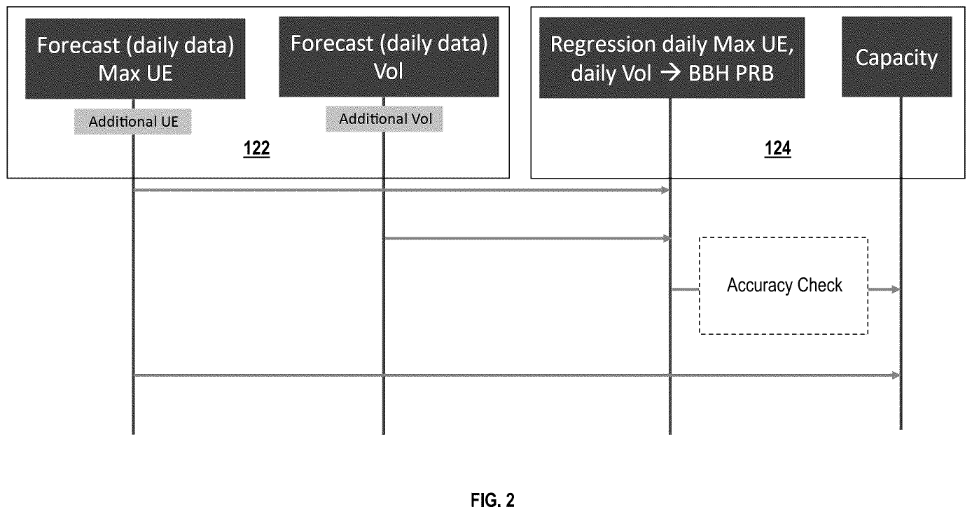

FIG. 2 is a diagram of example capacity forecasting operations, in accordance with some embodiments. FIG. 2 depicts neural net-based time series model 122 and machine learning regression model 124, each discussed above with respect to FIG. 1.

As depicted in FIG. 2, neural net-based time series model 122 generates Forecast (daily data) Max UE corresponding to the forecasted number of network users in each of one or more cells and Forecast (daily data) Vol corresponding to the forecasted traffic load of each of the one or more cells in the network. Machine learning regression model 124 receives the forecasted values and applies Regression on daily Max UE, daily Vol data to predict BBH PRB corresponding to predicting DL_PRB utilization of a specific cell and a percentage of maximum allowed users of the specific cell, from which the Capacity, or peak utilization of the specific cell is calculated, as discussed above with respect to FIG. 1.

In some embodiments, e.g., as discussed above with respect to FIG. 1, an updated forecasted number of network users is indicated by Additional UE, and an updated forecasted traffic load of the network is indicated by Additional Vol. In some embodiments, an Accuracy Check is performed prior to calculating the Capacity, and the Capacity is not calculated if a specific cell is determined to be inaccurate, e.g., by being outside of a predetermined percentage range of a specific parameter.

FIG. 3 is a diagram of example operations of capacity forecasting method 300, in accordance with some embodiments. Capacity forecasting method 300, also referred to as method 300 in some embodiments, is operable on a telecommunication system, e.g., telecommunication system 100 discussed above with respect to FIG. 1. In some embodiments, one or more operations of method 300 correspond to the operations discussed above with respect to FIG. 2.

Additional operations may be performed before, during, between, and/or after the operations of method 300 depicted in FIG. 3, and some other operations may only be briefly described herein. In some embodiments, other orders of operations of method 300 are within the scope of the present disclosure. In some embodiments, one or more operations of method 300 are not performed. In some embodiments, the operations of method 300 are included in another method, e.g., a method of operating and/or configuring a telecommunication system.

In some embodiments, some or all of the operations of method 300 discussed below are capable of being performed automatically, e.g., by apparatus 120 including neural net-based time series model 122 and machine learning regression model 124, each discussed above with respect to FIGS. 1 and 2 and/or by using processing circuitry 410 discussed below with respect to FIG. 4.

The operations of method 300 are discussed below with reference to various features of system 100 that are also discussed above respect to FIGS. 1 and 2.

At operation 310, in some embodiments, a neural net-based time series model and/or a machine learning regression model is trained on one or more time series datasets. In some embodiments, training the neural net-based time series model includes training neural net-based time series model 122 and/or training the machine learning regression model includes training machine learning regression model 124, each discussed above with respect to FIGS. 1 and 2.

At operation 320, telecommunication network data comprising cumulative daily data and peak utilization data are received at an apparatus. Receiving the telecommunication network data includes receiving the cumulative daily data at a neural net-based time series model on the apparatus. In some embodiments, receiving the telecommunication network data at the apparatus including the neural net-based time series model includes receiving RAN 104 data at apparatus 120 including neural net-based time series model 122 as discussed above with respect to FIG. 1.

At operation 330, a forecasted number of users in one or more cells of the network and a forecasted traffic load of the one or more cells in the network, each based on the cumulative daily data, is generated from the neural net-based time series model. In some embodiments, generating the forecasted number of users in the one or more cells of the network and the forecasted traffic load in the one or more cells of the network from the neural net-based time series model includes generating the forecasted number of users of the one or more cells and the forecasted traffic load of the one or more cells from neural net-based time series model 122 as discussed above with respect to FIGS. 1 and 2.

At operation 340, a predicted peak utilization of a cell of the network is calculated from the forecasted number of users and the forecasted traffic load for each of the one or more cells using the machine learning regression model. In some embodiments, using the machine learning regression model to calculate the predicted peak utilization of the cell of the network includes using machine learning regression model 124 to calculate the predicted peak utilization of cell 114 of RAN 104 as discussed above with respect to FIGS. 1 and 2.

In some embodiments, calculating the predicted peak utilization of the cell from the forecasted number of users and the forecasted traffic load includes predicting a DL_PRB utilization of the cell and a percentage of maximum allowed users of the cell, and adding a first product of the DL_PRB utilization and a first weight to a second product of the percentage of maximum allowed users and a second weight, as discussed above with respect to machine learning regression model 124 and FIG. 1.

At operation 350, in some embodiments, an updated predicted peak utilization of the cell is calculated, e.g., as discussed above with respect to FIG. 1.

In some embodiments, calculating the updated predicted peak utilization includes receiving, at the neural net-based time series model, a target increase in the forecasted number of users of the network, generating, from the neural net-based time series model, an estimated increase in the forecasted number of users based on the received target increase and an updated forecasted number of users in each of the one or more cells of the network and an updated forecasted traffic load in each of the one or more cells of the network, each based on the estimated increase, and calculating, using the machine learning regression model, an updated predicted peak utilization of the cell from the updated forecasted number of users and the updated forecasted traffic load.

In some embodiments, calculating the updated predicted peak utilization includes receiving, at the neural net-based time series model, information corresponding to a scheduled event, using the neural net-based time series model to identify a past event similar to the scheduled event based on the information, based on the past event, identify a subset of the cells of the network corresponding to the scheduled event, wherein the subset of cells comprises the cell, and estimate, for each cell of the subset of cells, an increase in a forecasted number of cell users and an increase in a forecasted cell traffic load, and using the machine learning regression model to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell.

At operation 360, in some embodiments, at least one KPI level of a planned non-roaming cell is estimated, e.g., as discussed above with respect to FIG. 1. In some embodiments, estimating the at least one KPI of the non-roaming cell includes using a similarity search algorithm, e.g., similarity search algorithm 126 discussed above, to identify at least one most similar second roaming cell by performing analysis of the first roaming cell and other roaming cells of the network proximate to non-roaming cells of the network, and based on one or more KPI levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell.

At operation 370, in some embodiments, a network resource configuration operation is performed in response to the predicted peak utilization of the cell exceeding a threshold. In some embodiments, performing the network resource configuration operation includes outputting a user notification or data from apparatus 120 as discussed above with respect to FIG. 1.

In some embodiments, performing the network resource configuration operation includes updating a database or other storage device corresponding to one or more network configuration programs.

In some embodiments, performing the network resource configuration operation includes adding, removing, and/or modifying one or more cells of the network.

By performing some or all of the operations of method 300, an apparatus, e.g., apparatus 120 of system 100, uses a neural net-based time series model and a machine learning regression model to predict a peak utilization of a cell such that a network including the cell is capable of being configured accordingly, thereby obtaining the benefits discussed above with respect to FIG. 1.

FIG. 4 illustrates an embodiment of a device 400. As shown in FIG. 4, the device 400 includes processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, an instruction device to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

### Supplemental Note 1

A method includes receiving, at an apparatus, telecommunication network data including cumulative daily data. A neural net-based time series model on the apparatus generates a forecasted number of users in a cell of the network and a forecasted traffic load in the cell of the network, each based on the cumulative daily data. A machine learning regression model on the apparatus calculates a predicted peak utilization of a cell of the network from the forecasted number of users and the forecasted traffic load.

### Supplemental Note 2

The method of Supplemental Note 1, further including receiving, at the neural net-based time series model, a target increase in the forecasted number of users of the network, generating, from the neural net-based time series model an estimated increase in the forecasted number of users based on the received target increase, and an updated forecasted number of users in the cell of the network and an updated forecasted traffic load in the cell of the network, each based on the estimated increase, and calculating, using the machine learning regression model, an updated predicted peak utilization of the cell from the updated forecasted number of users and the updated forecasted traffic load.

### Supplemental Note 3

The method of any Supplemental Notes 1 or 2, further including receiving, at the neural net-based time series model, information corresponding to a scheduled event, using a similarity search algorithm on the apparatus to identify a past event similar to the scheduled event based on the information, and based on the past event, identify a subset of the cells of the network corresponding to the scheduled event, wherein the subset of cells comprises the cell, and estimate, for each cell of the subset of cells, an increase in a forecasted number of cell users and an increase in a forecasted cell traffic load, and using the machine learning regression model to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell.

### Supplemental Note 4

The method of any Supplemental Notes 1-3, wherein the cell is a first roaming cell, and the method further includes using a (or the) similarity search algorithm on the apparatus to identify at least one most similar second roaming cell by performing an analysis of the first roaming cell and other roaming cells of the network proximate to non-roaming cells of the network, and using the neural net-based time series model to, based on one or more KPI levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell.

### Supplemental Note 5

The method of any Supplemental Notes 1-4, wherein calculating the predicted peak utilization of the cell from the forecasted number of users and the forecasted traffic load includes predicting a DL_PRB utilization of the cell and a percentage of maximum allowed users of the cell, and adding a first product of the DL_PRB utilization and a first weight to a second product of the percentage of maximum allowed users and a second weight.

### Supplemental Note 6

The method of Supplemental Note 5, wherein the first weight is equal to 0.8, and the second weight is equal to 0.2.

### Supplemental Note 7

The method of any Supplemental Notes 1-6, further including training the neural net-based time series model and/or the machine learning regression model is trained on one or more time series datasets.

### Supplemental Note 8

The method of any Supplemental Notes 1-7, wherein each of the receiving the cumulative daily data and the receiving the peak utilization data comprises receiving KPI data.

### Supplemental Note 9

The method of any Supplemental Notes 1-8, further including, in response to the predicted peak utilization of the cell exceeding a threshold, performing a network resource configuration operation.

### Supplemental Note 10

A method includes receiving, at an apparatus, telecommunication network key performance indicator (KPI) data including cumulative daily data and peak utilization data. A neural net-based time series model on the apparatus generates a forecasted number of users in a cell of the network and a forecasted traffic load in the cell of the network, each based on the cumulative daily data. A machine learning regression model on the apparatus calculates a predicted peak utilization of the cell of the network from the forecasted number of users and the forecasted traffic load of the cell. In response to the predicted peak utilization of the cell, a first network resource configuration operation is performed.

### Supplemental Note 11

The method of Supplemental Note 10, further including receiving, at the neural net-based time series model, a target increase in the forecasted number of users of the network, generating, from the neural net-based time series model an estimated increase in the forecasted number of users based on the received target increase, and an updated forecasted number of users in the cell of the network and an updated forecasted traffic load in the cell of the network, each based on the estimated increase, calculating, using the machine learning regression model, an updated predicted peak utilization of the cell from the updated forecasted number of users and the updated forecasted traffic load, and in response to the updated predicted peak utilization of the cell, performing a second network resource configuration operation.

### Supplemental Note 12

The method of any Supplemental Notes 10 or 11, further including receiving, at the neural net-based time series model, information corresponding to a scheduled event, using a similarity search algorithm on the apparatus to identify a past event similar to the scheduled event based on the information, using the neural net-based time series model to, based on the past event, identify a subset of the cells of the network corresponding to the scheduled event, wherein the subset of cells comprises the cell, and estimate, for each cell of the subset of cells, an increase in a forecasted number of cell users and an increase in a forecasted cell traffic load, using the machine learning regression model to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell, and in response to the predicted peak utilization of each cell of the subset of cells, performing a second network resource configuration operation comprising adding a temporary cell to the subset of cells.

### Supplemental Note 13

The method of any Supplemental Notes 10-12, wherein the cell is a first roaming cell, and the method further includes using a (or the) similarity search algorithm on the apparatus to identify at least one most similar second roaming cell by performing a machine learning-based time series similarity analysis of the first roaming cell and other roaming cells of the network proximate to non-roaming cells of the network, using the neural net-based time series model to, based on one or more KPI levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell, and in response to the estimated at least one KPI level of the planned non-roaming cell, performing a second network resource configuration operation.

### Supplemental Note 14

The method of any Supplemental Notes 10-13, wherein calculating the predicted peak utilization of the cell from the forecasted number of users and the forecasted traffic load of the cell includes predicting a DL_PRB utilization of the cell and a percentage of maximum allowed users of the cell, and adding a first product of the DL_PRB utilization and a first weight to a second product of the percentage of maximum allowed users and a second weight.

### Supplemental Note 15

The method of any Supplemental Notes 10-14, wherein performing the first network resource configuration operation is in response to the predicted peak utilization of the cell exceeding a cell capacity threshold.

### Supplemental Note 16

An apparatus includes a neural net-based time series model and a machine learning regression model. The neural net-based time series model is configured to receive telecommunication network KPI data including cumulative daily data and generate a forecasted number of users in a cell of the network and a forecasted traffic load in the cell of the network, each based on the cumulative daily data. The machine learning regression model is configured to calculate a predicted peak utilization of the cell of the network from the cell's forecasted number of users and the forecasted traffic load.

### Supplemental Note 17

The apparatus of Supplemental Note 16, wherein the neural net-based time series model is further configured to receive a target increase in the forecasted number of users of the network, generate an estimated increase in the forecasted number of users based on the received target increase, and generate an updated forecasted number of users in the cell of the network and an updated forecasted traffic load in the cell of the network, each based on the estimated increase, and the machine learning regression model is further configured to calculate an updated predicted peak utilization of the cell from the updated forecasted number of users and the updated forecasted traffic load.

### Supplemental Note 18

The apparatus of any Supplemental Notes 16 or 17, further comprising a similarity search algorithm configured to receive information corresponding to a scheduled event, identify a past event similar to the scheduled event based on the information, and based on the past event, identify a subset of the cells of the network corresponding to the scheduled event, wherein the subset of cells comprises the cell, wherein the neural net-based time series model is further configured to estimate, for each cell of the subset of cells, an increase in a forecasted number of cell users and an increase in a forecasted cell traffic load, and the machine learning regression model is further configured to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell.

### Supplemental Note 19

The apparatus of any Supplemental Notes 16-18, wherein the cell is a first roaming cell, the apparatus further comprises a (the) similarity search algorithm (further) configured to identify at least one most similar second roaming cell by performing analysis of the first roaming cell and other roaming cells of the network proximate to non-roaming cells of the network, and the neural net-based time series model is further configured to, based on one or more KPI levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell.

### Supplemental Note 20

The apparatus of any Supplemental Notes 16-19, wherein the machine learning regression model is configured to calculate the predicted peak utilization of the cell from the forecasted number of users and the forecasted traffic load by predicting a DL_PRB utilization of the cell and a percentage of maximum allowed users of the cell, and adding a first product of the DL_PRB utilization and a first weight to a second product of the percentage of maximum allowed users and a second weight.

The foregoing outlines features of several embodiments so that those skilled in the art better understand the aspects of the present disclosure. Those skilled in the art appreciate that they readily use the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that they make various changes, substitutions, and alterations herein without departing from the spirit and scope of the present disclosure

What is claimed is:

1. A method comprising:
receiving, at an apparatus, telecommunication network data comprising cumulative daily data and peak utilization data;
generating, from a neural net-based time series model on the apparatus, a forecasted number of users in a cell of the network and a forecasted traffic load in the cell of the network, each based on the cumulative daily data; and
calculating, using a machine learning regression model on the apparatus, a predicted peak utilization of a cell of the network from the forecasted number of users and the forecasted traffic load of the cell.

2. The method of claim 1, further comprising:
receiving, at the neural net-based time series model, a target increase in the forecasted number of users of the network;
generating, from the neural net-based time series model:
an estimated increase in the forecasted number of users based on the received target increase, and
an updated forecasted number of users in the cell of the network and an updated forecasted traffic load in the cell of the network, each based on the estimated increase; and
calculating, using the machine learning regression model, an updated predicted peak utilization of the cell from the updated forecasted number of users and the updated forecasted traffic load of the cell.

3. The method of claim 1, further comprising:
receiving, at the neural net-based time series model, information corresponding to a scheduled event;
using a similarity search algorithm on the apparatus to:
identify a past event similar to the scheduled event based on the information; and
based on the past event, identify a subset of the cells of the network corresponding to the scheduled event, wherein the subset of cells comprises the cell, and estimate, for each cell of the subset of cells, an increase in a forecasted number of cell users and an increase in a forecasted cell traffic load; and
using the machine learning regression model to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell.

4. The method of claim 1, wherein
the cell is a first roaming cell, and
the method further comprises:
using a similarity search algorithm on the apparatus to identify at least one most similar second roaming cell by performing an analysis of the first roaming cell and other roaming cells of the network proximate to non-roaming cells of the network; and
using the neural net based time series model to, based on one or more key performance indicator (KPI) levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell.

5. The method of claim 1, wherein the calculating the predicted peak utilization of the cell from the forecasted number of users and the forecasted traffic load comprises:
predicting a downlink physical resource block (DL_PRB) utilization of the cell and a percentage of maximum allowed users of the cell; and
adding a first product of the DL_PRB utilization and a first weight to a second product of the percentage of maximum allowed users and a second weight.

6. The method of claim 5, wherein
the first weight is equal to 0.8, and
the second weight is equal to 0.2.

7. The method of claim 1, further comprising:
training the neural net-based time series model and/or the machine learning regression model on one or more time series datasets.

8. The method of claim 1, wherein
each of the receiving the cumulative daily data and the receiving the peak utilization data comprises receiving key performance indicator (KPI) data.

9. The method of claim 1, further comprising:
in response to the predicted peak utilization of the cell exceeding a threshold, performing a network resource configuration operation.

10. A method comprising:
receiving, at an apparatus, telecommunication network key performance indicator (KPI) data comprising cumulative daily data and peak utilization data;
generating, from a neural net-based time series model on the apparatus, a forecasted number of users in a cell of the network and a forecasted traffic load in the cell of the network, each based on the cumulative daily data;
calculating, using a machine learning regression model on the apparatus, a predicted peak utilization of the cell of the network from the forecasted number of users and the forecasted traffic load of the cell; and
in response to the predicted peak utilization of the cell, performing a first network resource configuration operation.

11. The method of claim 10, further comprising:
receiving, at the neural net-based time series model, a target increase in the forecasted number of users of the network;
generating, from the neural net-based time series model:
an estimated increase in the forecasted number of users based on the received target increase, and
an updated forecasted number of users in the cell of the network and an updated forecasted traffic load in the cell of the network, each based on the estimated increase;
calculating, using the machine learning regression model, an updated predicted peak utilization of the cell from the updated forecasted number of users and the updated forecasted traffic load for the cell; and
in response to the updated predicted peak utilization of the cell, performing a second network resource configuration operation.

12. The method of claim 10, further comprising:
receiving, at the neural net-based time series model, information corresponding to a scheduled event;
using a similarity search algorithm on the apparatus to identify a past event similar to the scheduled event based on the information;
using the neural net-based time series model to, based on the past event, identify a subset of the cells of the network corresponding to the scheduled event, wherein the subset of cells comprises the cell, and estimate, for each cell of the subset of cells, an increase in a forecasted number of cell users and an increase in a forecasted cell traffic load;
using the machine learning regression model to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell; and
in response to the predicted peak utilization of each cell of the subset of cells, performing a second network resource configuration operation comprising adding a temporary cell to the subset of cells.

13. The method of claim 10, wherein the cell is a first roaming cell, and the method further comprises:
using a similarity search algorithm on the apparatus to identify at least one most similar second roaming cell by performing analysis of the first roaming cell and other roaming cells of the network proximate to non-roaming cells of the network;
using the neural net-based time series model to, based on one or more KPI levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell; and
in response to the estimated at least one KPI level of the planned non-roaming cell, performing a second network resource configuration operation.

14. The method of claim 10, wherein the calculating the predicted peak utilization of the cell from the forecasted number of users and the forecasted traffic load of the cell comprises:
predicting a downlink physical resource block (DL_PRB) utilization of the cell and a percentage of maximum allowed users of the cell; and
adding a first product of the DL_PRB utilization and a first weight to a second product of the percentage of maximum allowed users and a second weight.

15. The method of claim 10, wherein
the performing the first network resource configuration operation is in response to the predicted peak utilization of the cell exceeding a cell capacity threshold.

16. An apparatus comprising:
a neural net-based time series model configured to:
receive telecommunication network key performance indicator (KPI) data comprising cumulative daily data; and
generate a forecasted number of users in a cell of the network and a forecasted traffic load in the cell of the network, each based on the cumulative daily data; and
a machine learning regression model configured to calculate a predicted peak utilization of the cell of the network from the forecasted number of users and the forecasted traffic load for the cell.

17. The apparatus of claim 16, wherein
the neural net-based time series model is further configured to:
receive a target increase in the forecasted number of users of the network;
generate an estimated increase in the forecasted number of users based on the received target increase; and
generate an updated forecasted number of users in the cell of the network and an updated forecasted traffic load in the cell of the network, each based on the estimated increase, and
the machine learning regression model is further configured to calculate an updated predicted peak utilization of the cell from the updated forecasted number of users and the updated forecasted traffic load of the cell.

18. The apparatus of claim 16, further comprising a similarity search algorithm configured to:
receive information corresponding to a scheduled event;
identify a past event similar to the scheduled event based on the information; and
based on the past event, identify a subset of the cells of the network corresponding to the scheduled event, wherein the subset of cells comprises the cell,
wherein
the neural net-based time series model is further configured to estimate, for each cell of the subset of cells, an increase in a forecasted number of cell users and an increase in a forecasted cell traffic load, and
the machine learning regression model is further configured to calculate, for each cell of the subset of cells, a predicted peak utilization of the corresponding cell from the corresponding increased forecasted number of cell users and increased forecasted cell traffic load, wherein the predicted peak utilization of the cell is an updated predicted peak utilization of the cell.

19. The apparatus of claim 16, wherein
the cell is a first roaming cell,
the apparatus further comprises a similarity search algorithm configured to identify at least one most similar second roaming cell by performing an analysis of the first roaming cell and other roaming cells of the network proximate to non-roaming cells of the network, and
the neural net-based time series model is further configured to, based on one or more KPI levels of the at least one most similar second roaming cell relative to one or more KPI levels of the corresponding at least one proximate non-roaming cell, estimate at least one KPI level of the one or more KPI levels of a planned non-roaming cell corresponding to the first roaming cell.

20. The apparatus of claim 16, wherein the machine learning regression model is configured to calculate the predicted peak utilization of the cell from the forecasted number of users and the forecasted traffic load by:
predicting a downlink physical resource block (DL_PRB) utilization of the cell and a percentage of maximum allowed users of the cell; and
adding a first product of the DL_PRB utilization and a first weight to a second product of the percentage of maximum allowed users and a second weight.
